(19) United States
(12) Patent Application Publication
(10) Pub. No.: US 2008/0038435 A1
(43) Pub. Date: Feb. 14, 2008

(54) Precursor Formulation for Whippable Topping or Dessert Filling

(76) Inventor: Van Miller, Norval (CA)

Correspondence Address: GOWAN INTELLECTUAL PROPERTY, 1075 NORTH SERVICE ROAD WEST, SUITE 203, OAKVILLE, ON, L6M-2G2, US

(21) Appl. No.: 11/461,584

(22) Filed: Aug. 1, 2006

(51) Int. Cl. A23G 9/00

(52) U.S. Cl. 426/565

(57) ABSTRACT

A precursor formulation for a whippable dessert topping or filling comprising milk solids and vegetable fats has a water phase, which comprises bovine-derived water such as skim milk or buttermilk, or treated water having a pH and mineral content similar to bovine-derived water, in which skim milk solids are dissolved; and a vegetable fat/solids phase which has SFI characteristics similar to those of natural butterfat, is non-hydrogenated and has no trans-fatty acid constituents, and comprises both short chain vegetable oils having C12 to C14 carbon atoms, and long chain vegetable oils. The formulation comprises water phase of 50% to 76.8% by weight; vegetable fat, 12% to 35%, sugar, 10% to 12%; salt, 0.1% to 0.2%; lecithin and flavor, each 0.3% to 0.5%; and gums, 0.5% to 1.0%. A method of preparation of the precursor formulation includes mixing, heating, pasteurization, high pressure homogenization, cooling, high pressure re-homogenization, and packaging.

### FIELD OF THE INVENTION

This invention relates to dessert toppings and fillings, and particularly to dessert toppings and fillings that are whippable or in some circumstances that have been whipped. Particularly, the present invention relates to a precursor formulation for the whippable dessert toppings and fillings which can later be whipped or aerated for their particular use as a dessert topping or for fillings in pies and cakes. The precursor formulation for whippable dessert toppings and fillings in keeping with the present invention avoids any use of hydrogenated oils and/or trans-fatty acids. Moreover, the precursor formulation for whippable dessert toppings and fillings in keeping with the present invention allows for simple product labeling whereby the consumer can be assured of a healthier product than heretofore available.

### BACKGROUND OF THE INVENTION

Whipping cream has been used with various kinds of desserts and cooling as a topping for fruits and the like and as a filling for various kinds of cakes and pies. The use of whipping cream as a complement to the enjoyment of any dessert has probably been known for centuries. Indeed, up until the Second World War, whipping cream was very popular. However, during the war access to dairy products became limited, and all dairy products were in short supply. During the war, replacement products were brought to the market, and they typically employed various kinds of vegetable oils together with suitable and appropriate emulsifiers. However, while acceptable and used, such replacement dessert toppings were not wholeheartedly received, since they had relatively poor taste and their mouth feel was unappetizing.

After the war, rich desserts once again became fashion, and the use of whipping cream increased. By the 1970s, however, health concerns became more prominent, and many people began to worry about their intake of rich and fatty foods, their increase in cholesterol levels, and the impact of those matters on their general well-being. Moreover, the cost of dairy products was again increasing compared with other staple foods, and the trend became to reduce the intake of dairy products, and to increase the intake of reduced fat products.

At the same time, foods scientists, and particularly those having an interest in vegetable fats and oils, returned once again to the use of vegetable oils as a replacement for butterfat in many circumstances including a significant increase in the use of margarine instead of butter, as non-dairy creamers for coffee and the like, and in dessert fillings and toppings. Such products, however, employed significant quantities of hydrogenated fats, and later trans-fatty acids were also employed because such uses were believed to be acceptable.

Of course, it has been determined that hydrogenated fats and trans-fatty acids are more detrimental to human health then naturally occurring saturated fats such as those found in butterfat. Nonetheless, there are still several mitigating factors that suggest that there is still very widespread acceptance and desire in the market to consume dessert toppings and fillings that are prepared with vegetable oils rather than butterfat. Moreover, increased demand for such products, and the economics of bringing such products to the market as opposed to the cost of bringing similar products to the market that employ butterfat, leads to the conclusion that a healthier and cost-effective solution must be found so as to replace unacceptable reliance on hydrogenated fats and trans-fatty acids.

The inventor herein has unexpectedly discovered that a precursor formulation for whippable edible products which may be employed as dessert toppings and fillings can be provided, and at the same time a product which has a significant dairy constituent while simultaneously not only avoiding the use of butterfat but also avoiding the use of any hydrogenated fats or trans-fatty acids, is provided. To that end, as will be discussed in greater detail hereafter, the present invention provides a formulation for whippable dessert toppings and fillings that has a significant water phase and a vegetable fat/solids phase which will emulate in all respects natural whipping cream, but which will have significant shelf life and can be brought to the market economically.

One novel aspect of the present invention is that, in certain principal embodiments thereof, the inventor herein employs bovine-derived water, which means that the water phase of the precursor formulation is derived from dairy products. That means that the water content of liquid milk as it comes from dairy cattle and after it has been treated either to make buttermilk or skim milk has come to the attention of the inventor as being a suitable source of milk solids, while at the same time avoiding the use of butterfat. It will be understood, of course, that skim milk or buttermilk will contain 3% up to 12% of non-fat skim milk solids or buttermilk solids, thus providing the source of milk solids as noted immediately above.

However, it must at this time be stressed that by “buttermilk”, what is meant is that product which remains in a butter churn after butter has been removed therefrom. Real buttermilk production is tied, of course, to the production of butter. Thus, there may be some seasonal variation in costs and availability of buttermilk. However, essentially the same milk solids may also be found in skim milk from which all butterfat has been removed. Therefore, the use of bovine-derived water as the water phase of the precursor formulation of the present invention is an important feature in certain principal embodiments thereof.

Moreover, it will also be stressed that store-bought buttermilk is not the same as real buttermilk. Rather, store-bought buttermilk is a cultured skim milk which has been acidified. Thus, the use of store-bought buttermilk is not at all contemplated by the present invention, and is contrary to the purposes and goals of the present invention.

However, the present invention also contemplates the emulation of bovine-derived water by the provision of specially treated water which has been treated so as to have a pH and a mineral content similar to the water constituent of bovine-derived water such as that discussed above with respect to skim milk and buttermilk. But it must be noted that for use as the water phase in the formulation of the present invention, it is necessary as well to provide the necessary skim milk solids or buttermilk solids so as to effectively emulate skim milk or buttermilk. As a practical matter, the water must first be treated to adjust its pH and its mineral content to emulate that of bovine-derived water, after which skim milk powder or buttermilk powder is added. This is because, as a general rule, skim milk powders or buttermilk powders do not easily dissolve in water; or at least, the lactose and protein milk solids found in dried skim milk powder or buttermilk powder will not easily dissolve in water that has not at least been treated as to its pH to improve its affinity for the skim milk or buttermilk solids.

The present invention further contemplates that the precursor formulation for a whippable dessert topping or filling may be fortified by the addition of extra calcium that has been derived from milk. This is typically achieved in the dairy industry for drinking milk (usually, partially skimmed milk) by the addition of modified milk solids, but has been hitherto unknown for creams, and particularly whipping creams and the like.

More especially, the present invention seeks to provide the consumer with an enjoyable dessert product having flavor and mouth feel, whipping characteristics, and stability, similar to those of real whipped cream having approximately 35% butterfat; and at the same time to provide a healthy product having no hydrogenated oils and no trans-fatty acid constituents.

### DESCRIPTION OF THE PRIOR ART

The inventor herein is the author of a number of patents which relate in one way or another to milk products. They include U.S. Pat. No. 5,672,373 relating to the production of dry milk powder which has a fat content equivalent to that of dry whole milk; and U.S. Pat. No. 6,620,451 which relates to the preparation of a recombined cream formulation.

Another patent relating to a method for making a whipped cream filler having a milk fat constituent is Herrmann U.S. Pat. No. 5,494,694.

A series of patents which particularly relate to various technologies surrounding a commercial whipped topping composition, which may or may not comprise milk fat and which rely heavily on the use of hydrogenation, emulsifiers, cross-linked starches, and the like, includes U.S. Pat. Nos. 4,251,561; 4,451,492; 4,505,943; 5,077,076; 5,384,146; and 5,384,145.

### SUMMARY OF THE INVENTION

The present invention provides a precursor formulation for a whippable dessert topping or filling which will comprise milk solids and vegetable fats, and which has a water phase and a vegetable fat/solids phase.

The water phase of the precursor formulation of the present invention may comprise bovine-derived water chosen from the group which consists of skim milk, buttermilk derived from a butter churn, and mixtures and combinations thereof, and has 3% to 12% by weight of dissolved skim milk or buttermilk solids therein. Alternatively, the water phase of the precursor formulation of the present invention may comprise treated water which has a pH and mineral content similar to the water constituent of bovine-derived water, and to which skim milk or buttermilk solids have been added to the same extent as occurs in ordinary skim milk or buttermilk. Accordingly, this water phase also has 3% to 12% by weight of dissolved skim milk or buttermilk solids therein.

The vegetable fat constituent of the vegetable fat/solids phase has SFI characteristics similar to those of natural butterfat. Moreover, the vegetable fat constituent is non-hydrogenated and has no trans-fatty acid constituents. The vegetable fat constituent of the vegetable fat/solids phase may be chosen from the group consisting of short chain vegetable oils having C12 to C14 carbon atoms, long chain vegetable oils including particularly palm oil which is a C16 oil, and mixtures and combinations thereof.

The formulation is as follows:

| | |
|---|---|
| water phase* | 50% to 76.8% by weight |
| vegetable fat | 12% to 35% by weight |
| sugar | 10% to 12% by weight |
| salt | 0.1% to 0.2% by weight |
| lecithin | 0.3% to 0.5% by weight |
| flavor | 0.3% to 0.5% by weight |
| gums | 0.5% to 1.0% by weight |
| emulsifier | 0.5% to 3.0% by weight |

*including 3% to 12% by weight of dissolved skim milk or buttermilk solids

Moreover, the SFI characteristics of the vegetable fat constituent of the vegetable fat/solids phase are as follows:

| 10° C. | 40% to 43% |
|---|---|
| 20° C. | 21% to 22% |
| 30° C. | 5.5% to 7.5% |
| 40° C. | 0% |

In any embodiment of the present invention, the vegetable oils having C12 to C14 carbon atoms are chosen from the group which consists of palm kernel oil, fractionated palm kernel oil, coconut oil, babussu oil, tucum oil, shea butter, and mixtures and combinations thereof. None of these short chain vegetable oils has been hydrogenated.

The long chain vegetable oils that are employed may be chosen from the group which consists of soya bean oil, palm oil, canola oil, corn oil, flax seed oil, sunflower seed oil, and mixtures and combinations thereof.

Still further, the formulation of the present invention may in some circumstances comprise an additional up to 10% by weight of skim milk solids.

If so, then the additional skim milk solids are added to the formulation by the addition of condensed skim milk.

Moreover, the formulation of the present invention may further comprise additional calcium content, where the calcium has been derived from milk and has been added to the formulation by the addition of modified milk solids thereto.

The present invention also provides a method for the preparation of the precursor formulation hereof, wherein the method comprises the steps of:
(a) Mixing together the ingredients of the formulation and heating the same to a temperature of at least 78° C. so as to melt and dissolve the fat and solids ingredients.
(b) Blending the melted ingredients.
(c) Pasteurizing the blended ingredients at a temperature of at least 80° C.
(d) Homogenizing the pasteurized and blended ingredients at a temperature of at least 75° C. and at a pressure of 1000 psi to 7000 psi.
(e) Cooling the homogenized mixture to a temperature of 25° C. to 45° C.
(f) Re-homogenizing the cooled mixture at a temperature of 25° C. to 45° C. and at a pressure of 1000 psi to 7000 psi.
(g) Placing the re-homogenized mixture in containers and maintaining the same at a temperature of 10° C. to 45° C.

The containers which are chosen may be such as tanks, drums, aerosol containers, and combinations thereof.

The method of the present invention may further comprise the following steps:

(h) Whipping the cooled, re-homogenized mixture in whipping machine, so as to prepare a formulation having a predetermined specific gravity.
(i) Packaging the whipped formulation in predetermined quantities.
(j) Storing the packaged formulation at temperatures of −15° C. to 0° C.

It should be noted that when the product has been whipped so as to entrain air therein, then prior to step (j) the temperature of the package product is quickly reduced to below 0° C.

Finally, it is emphasized once again that the liquid water phase as it is employed in the methods of the present invention and in the preparation of the formulation in keeping with present invention may be bovine-derived water chosen from the group consisting of skim milk, buttermilk derived from a butter chum, and mixtures and combinations thereof; or it may be treated water having a pH and mineral content similar to the water constituent of bovine-derived water, and to which skim milk solids have been added to the same extent as occurs in ordinary skim milk or buttermilk. In all events, the water phase will have 3% to 12% by weight of dissolved skim milk or buttermilk solids therein.

### DETAILED DESCRIPTION OF THE INVENTION

The novel features which are believed to be characteristic of the present invention, as to its structure, organization, use and method of operation, together with further objectives and advantages thereof, will be better understood from the following discussion.

The formulation of the precursor for a whippable dessert topping or filling in keeping with present invention has been provided above. However, to reiterate what that formulation is, for purposes of the present discussion, it is as follows:

| | |
|---|---|
| water phase* | 50% to 76.8% by weight |
| vegetable fat | 12% to 35% by weight |
| sugar | 10% to 12% by weight |
| salt | 0.1% to 0.2% by weight |
| lecithin | 0.3% to 0.5% by weight |
| flavor | 0.3% to 0.5% by weight |
| gums | 0.5% to 1.0% by weight |
| emulsifier | 0.5% to 3.0% by weight |

*including 3% to 12% by weight of dissolved skim milk or buttermilk solids

Some discussion of each of the constituent components of the formulation is now given. First, it has been noted that the water phase of the formulation in keeping with present invention may comprise bovine-derived water which is typically skim milk or buttermilk which has been derived from a butter chum. Mixtures and combinations of those may also be employed. Alternatively, it has been noted that the water phase may be substituted by specially treated water which has been so treated so as to have a pH and mineral content similar to the water constituent of bovine-derived water, and to which skim milk or buttermilk solids have been added to the same extent as they will occur in ordinary skim milk. It is this water phase to which the other ingredients which comprise the vegetable fat/solids phase are mixed and blended. In all events, the water phase has 3% to 12% by weight of dissolved skim milk or buttermilk solids therein.

The vegetable oil constituent of the vegetable oil/solids phase typically comprises a mixture of short chain vegetable oils having C12 to C14 carbon atoms, blended with long chain vegetable oils so as to produce the proper and appropriate whipping, freezing, and taste profile such that the taste and mouth feel of the whipped topping, when whipped, will be essentially the same as that of real whipped cream. However, the blending comprises choosing appropriate short chain vegetable oils and long chain vegetable oils as may be economically available at the time of year and in the geographic location where the invention is being practiced.

Typically, short chain vegetable oils that find a particular usefulness in the practice of the present invention include palm kernel oil, fractionated palm kernel oil, coconut oil, babussu oil, tucum oil, and shea butter. Typical long chain vegetable oils include soya bean oil, palm oil, canola oil, corn oil, flax seed oil, and sunflower seed oil. Mixtures and combinations of those oils, and others, will provide SFI characteristics similar to those of natural butterfat, namely:

| 10° C. | 40% to 43% |
|---|---|
| 20° C. | 21% to 22% |
| 30° C. | 5.5% to 7.5% |
| 40° C. | 0% |

Thus, the vegetable oil constituent will have significant solids content at 10° C., and zero solids content at 40° C. Accordingly, the remaining constituents which comprise the vegetable fat/solids phase of the formulation in keeping with present invention may be melted and dissolved into the water phase at elevated temperatures. Then, upon homogenization and cooling, a whippable product which, upon whipping, will have a mouth feel similar to that of whipped cream, is provided.

### Still further, the appropriate blend of short chain oils along with long chain oils will create the proper melt profile and crystallization rate, whereby proper whippability and eating quality are achieved.

The addition of the remaining solids provides for the necessary sweetness, flavor, stability, and shelf life of the precursor formulation and/or the whipped dessert topping or filling which is produced therefrom. The purpose of the sugar and salt, and flavor, is self-evident; the purpose of the lecithin, gums, and emulsifier is to provide for shelf life and stability. These additional constituents, however, do not affect the storing or eating characteristics of the product. Moreover, the specific choice of flavor, gums, and emulsifier, is beyond the scope of the present invention but it will be evident to those skilled in the art that any suitable flavor such as vanilla extract or the like, and any suitable gums such as guar, carrageenan, xanthan, and mixtures and combinations thereof, may be employed. The emulsifier must be such that it is compatible with the non-fat milk solids, vegetable oils, and other constituents that are employed in formulations according to the present invention.

It has been noted that the vegetable fat constituent may be in a range of from 12% up to 35%. Typical “low fat” formulations of whipped toppings, and whipping cream sold in aerosol containers, comprise from 17% to 22% fat composition, but may be somewhat lower in some circumstances. In that case, it may be appropriate to add additional skim milk solids; and particularly, it may be appropriate to add condensed skim milk in order to provide for the addition of the further solids which might be required. If so, then condensed skim milk will form part of the water phase of the formulation of the present invention. Moreover, modified milk solids may be added, if required, to provide a higher calcium content than would otherwise occur; it being noted, however, that the additional calcium content is natural, and has been milk-derived. Real whipping cream typically comprises approximately 35% butterfat, and the intention of the present invention is to emulate that fat content, particularly in circumstances where richness of the dessert topping or filling is desired.

Still further, the fat composition constituent of the formulations in keeping with present invention may be structured having a full comprehension of the polymorphic behavior of the fats so that beta prime orienting lipids occur in the formulation in order to create emulsion stability and to control the latent heat release of the product when it is cooled; and particularly, when it is frozen. Otherwise the air holding capacity and stability of the whipped product may be compromised.

It has been noted above that mixtures and combinations of short chain and long chain vegetable oils can be blended into a blend which will have appropriate SFI characteristics similar to those of natural butterfat, and which will exhibit the proper melt profile and crystallization rate. Thus, when such oil blends are employed in the formulations of the present invention, the formulation will assure emulation of real whipped cream in such matters as viscosity, whippability, stability, and eating quality.

Reference is made to the following table, which shows typical SFI characteristics values for butterfat, palm oil, fractionated palm kernel oil, palm kernel oil, and a typical oil blend which can be employed in carrying out the present invention. That oil blend may be formulated from a mixture of fractionated palm kernel oil, coconut oil, soya oil, and canola oil, sunflower oil, or a mixture of canola and sunflower oils.

### Comparison SFI Chart

| | | | Fractionated | | |
|---|---|---|---|---|---|
| | | Palm | Palm | Palm Kernel | |
| | Butterfat | Oil | Kernel Oil | Oil | Blend |
| 10° C. | 40%–43% | 42.5% | 93%–95% | 53.5% | 40%–46% |
| 20° C. | 21%–22% | 21% | 92%–94% | 38% | 22%–24% |
| 30° C. | 5.5%–7.5% | 6.5% | 75%–85% | 0 | 6%–8% |
| 40° C. | 0 | 0 | 0 | 0 | 0 |

It will be seen that both palm oil and a blended short chain and long chain oil mixture in keeping with present invention have SFI characteristics that are not profoundly different than those of butterfat. However, those skilled in the art will understand that palm oil per se is not suitable for the purposes of providing the vegetable fat constituent of the vegetable fat/solids phase of the formulation of the present invention, which requires emulation of many other butterfat properties such as melt profile, crystallization rate, whippability, stability of a whipped product, and so on. It will also be appreciated by those skilled in the art that when non-fat milk solids are added to a blended fat system, in keeping with present invention, each incremental addition of solids will affect the firmness of the fat system in such a manner that the increasing firmness is essentially logarithmic in nature.

In carrying out the method of the present invention, it is noted that the first step is to mix all the ingredients of the formulation together and to heat the same to at least 78° C., so as to melt and dissolve the fat and solids ingredients. At same time, all the constituents are blended together. Then, the blended ingredients will be pasteurized at a temperature of at least 80° C. While the blended ingredients are still hot, at least above 75° C., they are then homogenized at a homogenization pressure of at least 1000 psi up to 7000 psi. All of those steps and the machinery that is used for them are well known to those skilled in the dairy arts, and particularly to those having experience with the production of whipped dairy products.

After the first homogenization step the product is then cooled to a temperature of 25° C. to 45° C. Thereafter, it is once again homogenized while at that lower temperature; and once again it is homogenized at pressures of 1000 psi to 7000 psi.

After the second homogenization step, the homogenized precursor formulation may then be packaged or placed in suitable containers and kept at temperatures not below 10° C. and not above 45° C. This homogenized precursor formulation finds a very ready market with commercial bakeries, hotels, and restaurants. There, the product will be used in the preparation of various desserts and baked goods which require a whipped topping or a whipped filling which will emulate the appearance, flavor, and mouth feel, of real whipped cream.

Other consumers of the homogenized precursor formulation may be producers of a whipped dessert topping of the sort sold in the retail market to household consumers. Thus, appropriate containerization for the homogenized precursor formulation when in its unwhipped condition may be such as tanks or drums in which large quantities may be delivered. On the other hand, the homogenized precursor formulation may also be placed into aerosol cans to be dispensed as a whipped topping, in particular; in which case it may find customers in both the commercial and retail markets.

When the product is whipped by being aerated in such as a Votator™ or other whipping machine, typically air is entrained into the product. If so, then it may be desirable for the whipped product to be packaged in individual small packages which are then sealed and treated in such a manner that the temperature of the packaged product is quickly reduced to below 0° C. This assures that surface area of the whipped product, and thus its overrun with respect to the original volume of the homogenized precursor formulation, remains stable; and the increased surface area of the whipped product decreases the freezing time.

### EXAMPLE 1

A precursor formulation in keeping with present invention had the following specific formula:

| | |
|---|---|
| buttermilk/skim milk water phase | 57% by weight |
| vegetable oil blend | 27% by weight |
| sugar | 14.7% by weight |
| salt | 0.1% by weight |
| lecithin | 0.3% by weight |
| flavor | 0.3% by weight |
| gums | 0.4% by weight |
| emulsifier | 0.2% by weight |

The formulation was manufactured in keeping with the steps of the present invention, as described above. The homogenization pressure at each of the hot and cool homogenization steps was 6000 psi.

The formulation had very good whippability and mouth sense, and was no different in any subjective test than whipping cream. The whipped product exhibited excellent air entertainment and stability, and could be substituted for whipped cream in eating tests.

There has been described typical formulations for a whippable dessert topping or filling which comprises milk solids and vegetable fats, and which avoids any use of hydrogenated fats or trans-fatty acids, but which emulates real whipping cream as to color, taste, mouth feel, and which provides a whipped product which emulates real whipped cream. It will be understood and appreciated that other modifications and variations to the formulations in keeping with present invention, and its method of production, will be evident to those skilled in the art and may be employed without, however, departing from the spirit and scope of the present claims.

Throughout this specification and the claims which follow, unless the context requires otherwise, the word “comprise”, and variations such as “comprises” or comprising, will be understood to imply the inclusion of a stated integer or step or group of stated integers or steps, but not to the exclusion of any other integer or step or group of integers or steps. It will also be understood that phrases such as “similar to” and “to the same extent” imply properties and ranges which are not dissimilar to those to which they have been compared, but which are not necessarily exactly the same.

1. A precursor formulation for a whippable dessert topping or filling comprising milk solids and vegetable fats, and having a water phase and a vegetable fat/solids phase;
wherein said precursor formulation is intended for storage in containers in an unwhipped condition at a temperature in the range of 10° C. to 45° C. and may be transported in said containers at said storage temperature:
wherein said water phase comprises bovine-derived water chosen from the group consisting of skim milk, buttermilk derived from a butter churn, and mixtures thereof, and said water phase has 3% to 12% by weight of dissolved skim milk solids or dissolved buttermilk solids therein; and
wherein the vegetable fat constituent of said vegetable fat/solids phase has SFI 1 characteristics substantially the same as those of natural butterfat, is non-hydrogenated and has no trans-fatty acid constituents, and is chosen from the group consisting of short chain vegetable oils having C12 to C14 carbon atoms, long chain vegetable oils, and mixtures thereof;
wherein said formulation comprises the following constituents:

| | |
|---|---|
| water phase | 50% to 76.8% by weight |
| vegetable fat | 12% to 35% by weight |
| sugar | 10% to 12% by weight |
| salt | 0.1% to 0.2% by weight |
| lecithin | 0.3% to 0.5% by weight |
| flavor | 0.3% to 0.5% by weight |
| gums | 0.5% to 1.0% by weight |
| emulsifier | 0.5% to 3.0% by weight |

and wherein the SFI characteristics of the vegetable fat constituent of said vegetable fat/solids phase are:

| 10° C. | 40% to 43% |
|---|---|
| 20° C. | 21% to 22% |
| 30° C. | 5.5% to 7.5% |
| 40° C. | 0%. |

2. A precursor formulation for a whippable dessert topping or filling comprising milk solids and vegetable fats, and having a water phase and a vegetable fat/solids phase;
wherein said precursor formulation is intended for storage in containers in an unwhipped condition at a temperature in the range of 10° C. to 45° C., and may be transported in said containers at said storage temperature:
wherein said water phase comprises water having a pH and mineral content substantially the same as the water constituent of bovine-derived water, and said water phase has skim milk solids or buttermilk solids which have been added thereto to the extent of 3% to 12% by weight of dissolved skim milk solids or dissolved buttermilk solids therein;
wherein the vegetable fat constituent of said vegetable fat/solids phase has SFI characteristics substantially the same as those of natural butterfat, is non-hydrogenated and has no trans-fatty acid constituents, and is chosen from the group consisting of short chain vegetable oils having C12 to C14 carbon atoms, long chain vegetable oils, and mixtures thereof;
wherein said formulation comprises the following constituents:

| | |
|---|---|
| water phase | 50% to 76.8% by weight |
| vegetable fat | 12% to 35% by weight |
| sugar | 10% to 12% by weight |
| salt | 0.1% to 0.2% by weight |
| lecithin | 0.3% to 0.5% by weight |
| flavor | 0.3% to 0.5% by weight |
| gums | 0.5% to 1.0% by weight |
| emulsifier | 0.5% to 3.0% by weight |

and wherein the SFI characteristics of the vegetable fat constituent of said vegetable fat/solids phase are:

| 10° C. | 40% to 43% |
|---|---|
| 20° C. | 21% to 22% |
| 30° C. | 5.5% to 7.5% |
| 40° C. | 0%. |

3. The formulation of claim of 1, wherein said vegetable oils having C12 to C14 carbon atoms are unhydrogenated, and are chosen from the group consisting of palm kernel oil, fractionated palm kernel oil, coconut oil, babussu oil, tucum oil, shea butter, and mixtures thereof; and
wherein said long chain vegetable oils are chosen from the group consisting of soya bean oil, palm oil, canola oil, corn oil, flax seed oil, sunflower seed oil, and mixtures thereof.

4. The formulation of claim of 2, wherein said vegetable oils having C12 to C14 carbon atoms are unhydrogenated, and are chosen from the group consisting of palm kernel oil, fractionated palm kernel oil, coconut oil, babussu oil, tucum oil, shea butter, and mixtures thereof; and
wherein said long chain vegetable oils are chosen from the group consisting of soya bean oil, palm oil, canola oil, corn oil, flax seed oil, sunflower seed oil, and mixtures thereof.

5. (canceled)

6. (canceled)

7. (canceled)

8. (canceled)

9. (canceled)

10. (canceled)

11. A method of preparation of a precursor formulation for a whippable dessert topping or filling comprising milk solids and vegetable fats, and having a liquid water phase and a vegetable fat/solids phase;
wherein said liquid water phase is bovine-derived water chosen from the group consisting of skim milk, buttermilk derived from a butter churn, and mixtures and combinations thereof, and has 3% to 12% by weight of dissolved skim milk or buttermilk solids therein;
wherein the vegetable fat constituent of said vegetable fat/solids phase is chosen from the group consisting of short chain vegetable oils having C12 to C14 carbon atoms, long chain vegetable oils, and mixtures and combinations thereof; and
wherein said formulation comprises:

| | |
|---|---|
| water phase | 50% to 76.8% by weight |
| vegetable fat | 12% to 35% by weight |
| sugar | 10% to 12% by weight |
| salt | 0.1% to 0.2% by weight |
| lecithin | 0.3% to 0.5% by weight |
| flavor | 0.3% to 0.5% by weight |
| gums | 0.5% to 1.0% by weight |
| emulsifier | 0.5% to 3.0% by weight |

said method comprising the steps of:
(a) mixing together the ingredients of said formulation and heating the same to a temperature of at least 78° C. so as to melt and dissolve the fat and solids ingredients;
(b) blending said melted ingredients;
(c) pasteurizing said blended ingredients at a temperature of at least 80° C.;
(d) homogenizing said pasteurized and blended ingredients at a temperature of at least 75° C. and at a pressure of 1000 psi to 7000 psi;
(e) cooling said homogenized mixture to a temperature of 25° C. to 45° C.;
(f) re-homogenizing said cooled mixture at a temperature of 25° C. to 45° C. and at a pressure of 1000 psi to 7000 psi;
(g) placing said re-homogenized mixture in containers and maintaining the same at a temperature of 10° C. to 45° C.

12. The method of claim 11, wherein said containers are chosen from the group consisting of tanks, drums, aerosol containers, and combinations thereof.

13. The method of claim 11, further comprising the steps of:
(h) whipping the cooled, re-homogenized mixture in a whipping machine so as to entrain air therein, and thereby so as to prepare a formulation having a predetermined specific gravity;
(i) packaging the whipped formulation in predetermined quantities; and
(j) storing the packaged formulation at temperatures of −15° C. to 0° C.

14. The method of claim 13, wherein prior to step (j), the temperature of the packaged product is quickly reduced to below 0° C.

15. The formulation of claim 1, wherein said stored precursor formulation may be whipped to have a predetermined specific gravity, packaged in predetermined quantities, and then stored at a storage temperature in the range of −15° C. to 0° C.

16. The formulation of claim 2, wherein said stored precursor formulation may be whipped to have a predetermined specific gravity, packaged in predetermined quantities, and then stored at a storage temperature in the range of −15° C. to 0° C.
